(19) United States
(12) Patent Application Publication
(10) Pub. No.: US 2004/0033812 A1
(43) Pub. Date: Feb. 19, 2004

(54) Wireless communication apparatus, program and method

(75) Inventors: Kozo Matsunaga, Sagamihara-shi (JP); Masaharu Itoh, Yamato-shi (JP); Kazuo Fujii, Yokohama-shi (JP)

Correspondence Address: IBM Corporation, Personal and Printing Systems Group Legal Dept., Dept. 9CCA/Bldg. 002-2, P.O. Box 12195, Research Triangle Park, NC, 27709, US

(73) Assignee: International Business Machines Corporation, Armonk, NY

(21) Appl. No.: 10/222,498

(22) Filed: Aug. 16, 2002

(51) Int. Cl. H04M 1/00

(52) U.S. Cl. 455/557; 455/572; 455/434

(57) ABSTRACT

The present invention provides a method, apparatus and program for suppressing a power unit of a computer given a limited power capacity of the power unit, and in particular for more effectively suppressing power consumption of computers having or using a wireless LAN module.

### BACKGROUND OF THE INVENTION

1. Field of the Invention

The present invention relates to a wireless communication apparatus and method that suppresses power consumption in various applications.

2. Background of Related Art

Conventionally, small and portable computer-based devices, such as lap-top personal computers (PCs) and personal digital assistants (PDAs), have become widely used. Often these computer-based devices, hereinafter referred to as computers, are used at a predetermined place, such as in an office or at home. Additionally, these computers often use an AC adapter for providing power to the computer unit. However, when the computer is used away from the home or office, such as in a mobile setting (e.g., train, car, etc.) the computer must be powered by a built-in power unit (i.e., a battery). This power unit is often designed so that an AC voltage of the power source is converted to DC 12V, 5V, or 3.3V so as to supply power for the mother board and various components in the computer.

It is also known to provide additional function beyond that of basic computing to a computer. An example of this additional function include communications. For instance, it is known that a computer may be provided with a wireless LAN module, used as a wireless communication module, so as to enable data sending/receiving to/from external via a network. With such a wireless LAN module installed in the computer, the computer can send/receive data to/from external easily even at a place away from the office/home as long as data can be sent/received to/from a wireless base station.

However, the use of additional function, and features, of a computer often requires that additional power above a basic amount be consumed by the computing device to effect the operation of the additional function(s). For instance, after being connected to a network via a wireless LAN, a wireless LAN module may maintain a link with a wireless radio station, resulting in a continued consumption of a certain power to maintain the operation of the wireless LAN.

As a result, the net operating time of a computer is often decreased especially where there exists a limited-capacity power unit used as a power supply for the computer, with an increased requirement for power consumption due to the additional operative functions.

It is therefore desired to have a method and an apparatus for suppressing a power unit of a computer in order to reduce the power consumption of the unit, especially where the power unit is of a limited power capacity.

### SUMMARY OF THE INVENTION

The present invention provides a method, apparatus and program for suppressing a power unit of a computer given a limited power capacity of the power unit, and in particular for more effectively suppressing power consumption of computers having or using a wireless LAN module. It is therefore an object of the present invention to provide a wireless communication module that can suppress power consumption.

In order to achieve the above object and others of the present invention, the computer of the present invention can connect with a wireless communication module that can send/receive data to/from an access point. The computer includes a power supply detection unit that detects whether or not an AC power supply is used to power the computer; and an operation mode controller that controls an operation mode in the wireless communication module according to the decision of the power supply detection unit. The operation mode can be changed according to the type of the power supply to suppress power consumption.

For example, when the power supply detection unit detects that an AC power supply is used to power the computer, the operation mode controller can set a first mode as the operation mode. When it is detected that an AC power supply is not used to power the computer, the controller can set a second mode as the operation mode. For example, the first mode is a normal mode and the second mode is a power save mode.

The computer of the present invention may further include a scanning controller that controls an access point scanning and a detection unit that detects whether or not communication with the access point is enabled. In the instant case, the scanning controller, when the detection unit detects that the communication is disabled, can set an idle time until the next access point scanning begins, longer than when the communication is enabled. The operation mode controller, when the communication is disabled, can set a third mode as the operation mode. In addition, the scanning controller, when the third mode is set, can scan the access point upon an event occurrence. The third mode means, for example, a sleep mode.

Furthermore, the computer of the present invention provided with a wireless communication module further includes a scanning controller that controls access point scanning; and a detection unit that detects whether or not communication with an access point is enabled. The scanning controller, when the detection unit detects that the communication is disabled, sets an idle time until the next access point scanning begins, longer than when the communication is enabled. In this instant case, the computer may also be provided with, for example, a detector that detects an event occurrence. The scanning controller, when the detection unit detects that the communication is disabled, can stop scanning until the detector detects another event.

The present invention may also include a wireless communication module. This wireless communication module includes a scanning unit that scans an access point; a detection unit that detects whether or not communication with the access point is enabled; and an operation mode controller that controls an operation mode for selecting the unit to be supplied with a power in the wireless communication module according to the detection unit.

The wireless communication module of the present invention is connected to a computer and enables the computer to make a wireless communication connection. The wireless communication module includes a first mode operation unit that operates itself in the first mode when an AC power supply is used to power the computer and a second mode operation unit that operates itself in the second mode when the AC power supply is not used to power the computer. In this case, the wireless communication module may also include a scanning unit that scans an access point and a third mode operation unit that operates itself in a third mode when the communication with the access point is disabled.

The present invention may also include a method for controlling the above-described wireless communication module. This controlling method that enables data sending/receiving to/from an external network includes a step of scanning an access point; a step of detecting whether or not communication with the access point is enabled; and a step of setting t1 as an idle time until the next scanning begins when communication with the access point is enabled and sets t2 as an idle time when communication with the access point is disabled. In this case, t1 and t2 satisfy the condition of t1<t2.

The present invention may also be a program. This program enables a computer to execute a function for setting a first mode as the operation mode of the wireless communication module when an AC power supply is used to power the computer and a function for setting a second mode as the operation mode of the wireless communication mode when the AC power supply is not used to power the computer.

Furthermore, the present invention may be execution code on a recording medium. This recording medium stores a program to be executed by the computer so as to be read by the computer. The program enables the computer to execute a function for detecting whether or not an AC power supply is used to power the computer and a function for setting a first mode as the operation mode of the wireless communication module when the AC power supply is used to power the computer and sets a second mode as the operation mode of the wireless communication module when the AC power supply is not used to power the computer.

As used herein the term “program” and “programs” may also include a microcomputer, a processing unit from a remote program transmission device, a network, software code, an electromechanical process, and the like. The program transmission device may be configured to comprise storage means such as a CD-ROM, a DVD, a memory or a hard-disc with the programs stored therein, and a transmission means for reading the programs from the storage means and transmitting the programs to a device for executing the programs, via connectors and networks such as Internet or LAN. The programs may be provided by using a storage medium such as CD-ROM or may be accessible via a wired or wireless connection or network.

### BRIEF DESCRIPTION OF THE DRAWINGS

Other aspects, features, and advantages of the present invention will become more fully apparent from the following detailed description, the appended claims, and the accompanying drawings in which:

FIG. 1 is a hardware block diagram of a computer system according to a preferred embodiment of the present invention;

FIG. 2 is a block diagram of a wireless LAN card shown in FIG. 1;

FIG. 3 is a process flowchart in a computer system of the present invention, according to a preferred embodiment;

FIG. 4 is an example of denoting a state of the power supply to the components of the wireless LAN card in the power save mode, according to a preferred embodiment of the present invention;

FIG. 5 is an example of denoting a state of the power supply to the components of the wireless LAN card in the deep sleep mode, according to a preferred embodiment of the present invention; and FIG. 6 is a variation of the block diagram of the wireless LAN card shown in FIG. 2.

### DETAILED DESCRIPTION OF THE INVENTION

Hereunder, a preferred embodiment of the present invention will be described in detail with reference to the accompanying drawings.

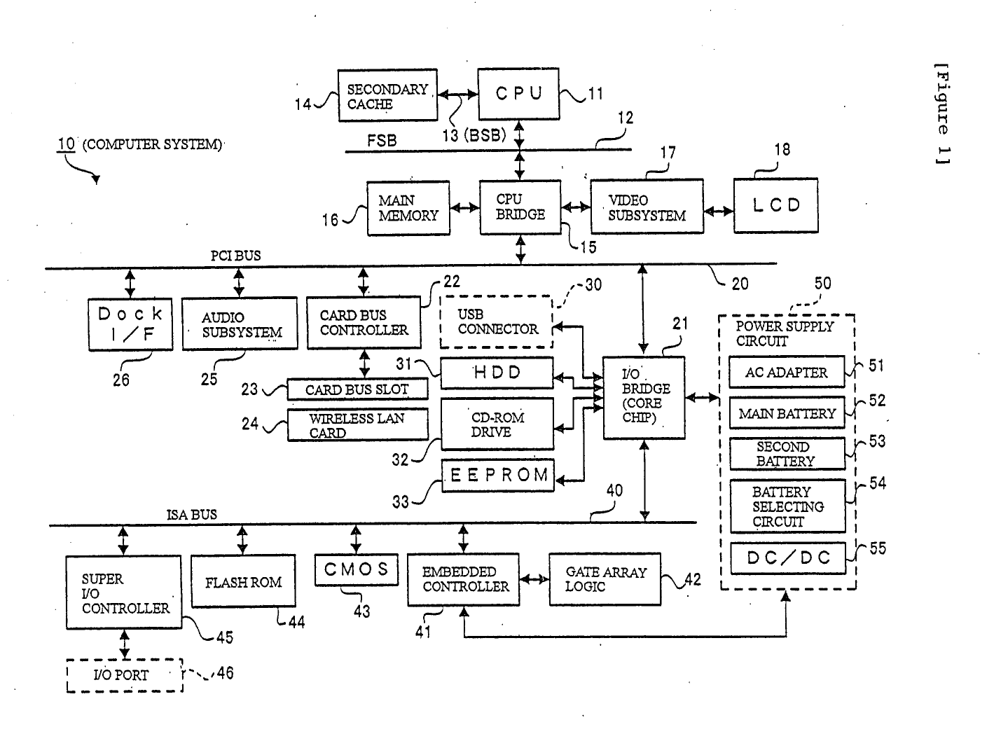

FIG. 1 shows a hardware block diagram of a computer system (computer) 10 according to a preferred embodiment of the present invention. A computer provided with the computer system 10, for example, includes, for purposes of exemplification, a lap-top PC (Personal Computer) conforming to the specifications of the OADG (Open Architecture Developer's Group), and, a predetermined OS (Operating System) installed in the lap-top PC.

In the computer system 10 shown in FIG. 1, a CPU (operation mode controller, scanning controller) 11 functions as a brain of the whole computer system 10 and executes various programs under the control of the OS. The CPU 11 is connected to each component of the computer system 10 via three buses of an FSB (Front Side Bus) 12 that is a system bus, a PCI (Peripheral Component Interconnect) bus 20 used for fast I/O devices, and an ISA (Industry Standard Architecture) bus 40 used for slow I/O devices.

The operation of this CPU 11 is sped up by storing program codes and data in cache memory. In recent years, an SRAM of about 128 KB has been integrated in the CPU 11 as a primary cache, and a secondary cache 14 of about 512 KB to 2 MB is connected to the CPU 11 via an exclusive bus BSB (Back Side Bus) 13 so as to make up for a shortage of the capacity. However, it is also possible to omit the BSB 13 and connect the secondary cache 14 to the FSB 12, thereby avoiding the use of a package with many terminals and suppressing the manufacturing cost.

The FSB bus 12 and the PCI bus 20 are connected to each other via a CPU bridge (host PCI bridge) 15 referred to as a memory/PCI chip. This CPU bridge 15 is composed so as to include the memory controller function used to control the accesses to the main memory 16 and a data buffer used to absorb the difference of the data transfer speed between the FSB 12 and the PCI bus 20. The main memory 16 is a readable memory used as an area in which executable programs of the CPU 11 are read or as a working area in which processed data of those executable programs are written. For example, the main memory 16 is composed of a plurality of DRAM chips (a standard capacity of 64 MB and expandable up to 320 MB). The executable programs to be read into the main memory 16 are an OS, various drivers used to operate peripheral devices and other hardware items, application programs used for specific business works, and such firmware items as the BIOS (Basic Input/Output System) stored in a flash ROM 44 (to be described later).

A video subsystem 17 is used to execute video-related functions and the video subsystem 17 includes a video controller. This video controller processes a drawing instruction issued from the CPU 11, writes processed drawing information in a video memory, reads the drawing information from the video memory, and outputs the information onto a liquid crystal display (LCD) 18 as drawing data.

The PCI bus 20 is used to transfer comparatively fast data. The PCI bus 20 is standardized so as to have a data bus width of 32 bits or 64 bits, the maximum operation frequency of 33 MHz or 66 MHz, and the maximum data transfer rate of 132 MB/sec or 528 MB/sec. This PCI bus 20 is connected to an I/O bridge (operation mode controller, scanning controller, power supply detection unit) 21, a card bus controller 22, an audio subsystem 25, and a docking station interface (Dock I/F) 26 respectively.

The card bus controller 22 is used to connect bus signals of the PCI bus 20 to the interface connector (card bus) of a card bus slot 23 directly. This card bus slot 23 is provided with a wireless LAN card (wireless communication module) 24 that is a PC card. The docking station interface 26 is a hardware item used to connect the docking station (not shown) that is an extension device of the computer system 10. When a laptop PC is connected to the docking station, various hardware items connected to the internal bus of the docking station can be connected to the PCI bus 20 via the docking station interface 26.

The I/O bridge 21 is provided with the function of bridging between the PCI bus 20 and the ISA bus 40. The I/O bridge 21 is also provided with the DMA controller function, the programmable interrupt controller (PIC) function, the programmable interval timer (PIT) function, the IDE (Integrated Device Electronics) interface function, the USB (Universal Serial Bus) function, and the SMB (System Management Bus) interface function. And, the I/O bridge 21 incorporates a real time clock (RTC) in itself.

The DMA controller function enables data to be transferred between such peripheral devices as an FDD, etc. and the main memory 16 without using the CPU 11. The PIC function enables a predetermined program (interrupt handler) to be executed in response to an interrupt request (IRQ) issued from a peripheral device. The PIT function generates timer signals at predetermined cycles.

The interface realized by the IDE interface function is connected to an IDE hard disk drive (HDD) 31, as well as a CD-ROM drive 32 via the ATAPI (AT Attachment Packet Interface). Instead of this CD-ROM drive 32, other types of IDE devices such as a DVD (Digital Versatile Disc) drive may be connected to the interface. Such external storages as the HDD 31, the CD-ROM drive 32, etc. are housed in a place referred to as a “media bay” or “device bay” in the lap-top PC. Those external storages provided as standard may be replaced with other devices such as an FDD, a battery, etc. or attached exclusively.

The I/O bridge 21 is provided with a USB port connected to a USB connector 30 provided, for example, on a chassis, etc. of the lap-top PC. The I/O bridge 21 is also connected to an EEPROM 33 via an SM bus. This EEPROM 33 is a non-volatile memory used to hold such information as a user registered password, a supervisor password, a serial number of the product, etc. The data stored in this EEPROM 33 can thus be rewritable electrically.

The I/O bridge 21 is connected also to a power supply circuit 50. The power supply circuit 50 is provided with an AC adapter 51, a battery selecting circuit 54 that charges the main battery 52 used as a secondary battery or second battery 53 and selects a power supply path from the AC adapter 51 and from each of the batteries, and a DC/DC converter (DC/DC) 55 that generates such DV voltages as 5V, 3.3V, etc. used for the computer system 10, and other circuits.

On the other hand, inside the core chip that compose the I/O bridge 21 are provided with an internal register block used to manage the power supply state in the computer system 10 and a logic circuit (state machine) used to manage the power supply state in the computer system 10, as well as the operation of this internal register block. This logic circuit sends/receives various signals to/from the power supply circuit 50, thereby recognizing the actual state of the power supply from the power supply circuit 50 to the computer system 10. The power supply circuit 50 controls the power supply to the computer system 10 according to the command from this logic circuit.

The ISA bus 40 is slower than the PCI bus 20 in data transfer rate (for example, the bus width is 16 bits and the maximum data transfer rate is 4 MB/sec). This ISA bus 40 is connected to an embedded controller 41 (power supply detection unit) connected to a gate array logic 42, a CMOS 43, a flash ROM 44, and a super I/O controller 45. The ISA bus 40 is also used to connect such peripheral devices as a keyboard/mouse controller whose operations are comparatively slow. The super I/O controller 45 is connected to an I/O port 46 (detector) and used to control operation of the FDD, input/output of parallel data via a parallel port (PIO), and input/output of serial data via a serial port (SIO).

The embedded controller 41 controls a keyboard (not shown). The embedded controller 41 connected to the power supply circuit 50 also enables a built-in power management controller (PMC) to take charge of the power management function together with the gate array logic 42.

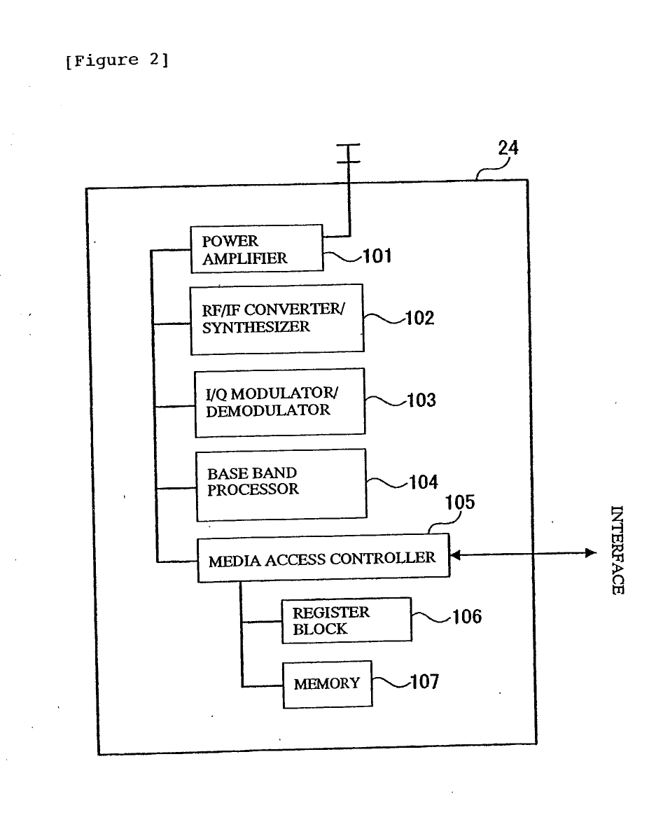

FIG. 2 shows a concrete block diagram of a wireless LAN card 24 shown in FIG. 1.

The wireless LAN card 24 is provided with a power amplifier 101 connected to an antenna, an RF/IF converter/synthesizer 102, an I/Q modulator/demodulator 103, a base band processor 104, and a media access controller 105 used to control sending/receiving of radio waves. The media access controller 105 is provided with a register block 106 and a memory 107. This wireless LAN card 24 conforms to, for example, the IEEE802.11 standard. The wireless LAN card 24 is classified into three types; those using the 2.4 GHz band radio, those using the 5 GHz band radio, and those using infrared rays.

Usually, when sending/receiving data to/from external via a wireless LAN, an access point is searched periodically to assure sending/receiving of data. When a target access point is to be searched, at first access points are scanned with a predetermined frequency radio to find the target one that can establish the communication. When data sending/receiving to/from the access point is enabled, data sending/receiving begins after the communication establishment between the access point and the computer system 10 is confirmed. Hereafter, a description for how to control the scanning by the wireless LAN card 24 in this embodiment is provided.

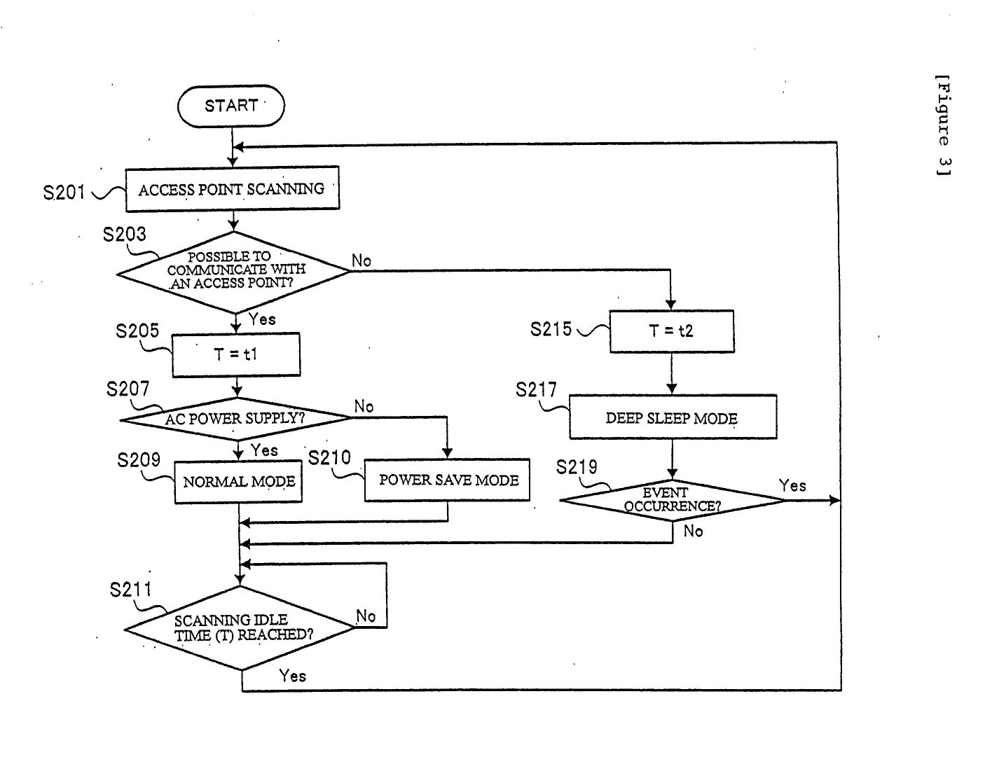

FIG. 3 is a flowchart of the processes executed in the computer system 10, according to a preferred embodiment.

In the computer system 10, at first access points are scanned (step S201). A control software program of the wireless LAN card 24 executed in the computer system 10 instructs the scanning of access points. The OS (Operating System) of the computer system 10 may also be used for this controlling.

Next, it is detected whether or not communication with an access point detected in the scanning can be enabled (step S203). Because accurate data sending/receiving to an access point is enabled only when the radio signal strength of the access point is above a certain level, every detected access point in the scanning may not be enabled for data sending/receiving. It is therefore detected here whether or not the radio signal from the access point is received at a predetermined strength or more.

When it is determined in step S203 that the communication is enabled, the scanning idle time T is set to t1 (step S205). On the other hand, when it is determined that the communication is disabled, the scanning idle time T is set to t2 (step S215). At this time, t1 and t2 can be set freely if the condition of t1<t2 is satisfied. For example, a service provider can set them in advance or upon a request of a user. For example, when the computer system 10 is used away from the office/home, that is, when data sending/receiving is not always required, it is possible to set t2 longer and when the computer system 10 is used in the office and data is sent/received frequently, it is possible to set t2 shorter. The scanning idle time can be set, for example, as t1=10 to 15 sec and t2=30 to 60 sec.

When t1 is set shorter than t2 as the scanning idle time and, for example, it is detected that communication with an access point is enabled, then data can be sent/received periodically. In addition, data might actually be sent/received in such a case, data sending/receiving should be kept checked. This is why the scanning idle time is set shorter in step S205. On the other hand, when it is detected that communication with an access point is disabled, it is rare that the computer system 10 is moved suddenly and communication with an access point is enabled suddenly. It is thus possible to set the scanning idle time longer in step S215 to suppress the power consumption in the scanning.

When the scanning idle time T is set to t1 (shorter) in step S205, it is then detected whether or not an AC power supply is used to operate the computer system 10 (step S207). This decision can be done, for example, by checking whether or not the I/O bridge 21 of the computer system 10 is powered from the AC adapter 51 of the power supply circuit 50. The decision can also be done on the basis of a signal received from the embedded controller 41. When it is detected that an AC power supply is used to operate the computer system 10, the operation mode of the wireless LAN card 24 is set to the normal mode (step S209).

The normal mode means a state in which data can be received from the target access point any time. Concretely, the normal mode means a state in which the power amplifier 101, the RF/IF converter/synthesizer 102, the I/Q modulator/demodulator 103, the base band processor 104, and the media access controller 105 in the wireless LAN card 24 are powered respectively. Consequently, in the normal mode, comparatively much power is consumed in the wireless LAN card 24.

On the other hand, when it is detected in step S207 that the AC power supply is not used to operate the computer, that is, when the main battery 52 is used to operate the computer system 10, the power save mode is set as the operation mode of the wireless LAN card 24 (step S210).

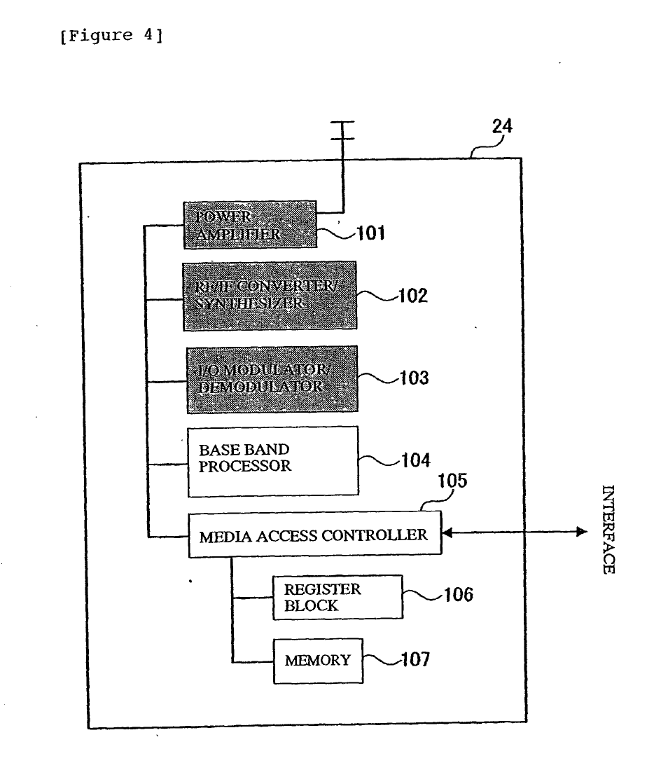

The power save mode means a state in which data is received at a predetermined timing; data cannot always be received. FIG. 4 shows how the components of the wireless LAN card 24 are powered in the power save mode while no data is sent/received. In FIG. 4, the power amplifier 101, the RF/IF converter/synthesizer 102, and the I/Q modulator/demodulator 103 that are hatched are not powered while the base band processor 104 and the media access controller 105 are powered. In the power save mode, all the components that must be powered are powered only at data sending/receiving timings, so that the power consumption can be suppressed low when data sending/receiving stops (when no data can be sent/received).

When the main battery 52 is used to power the computer system 10, the power to be stored in the main battery 52 is limited in capacity. In such a case, therefore, the power save mode can be set to suppress the power consumption when the main battery 52 supplies the power.

Next, a description for a process to be executed is provided when the scanning idle time is set to t2 in step S215, according to the decision that communication with an access point is disabled in step S203.

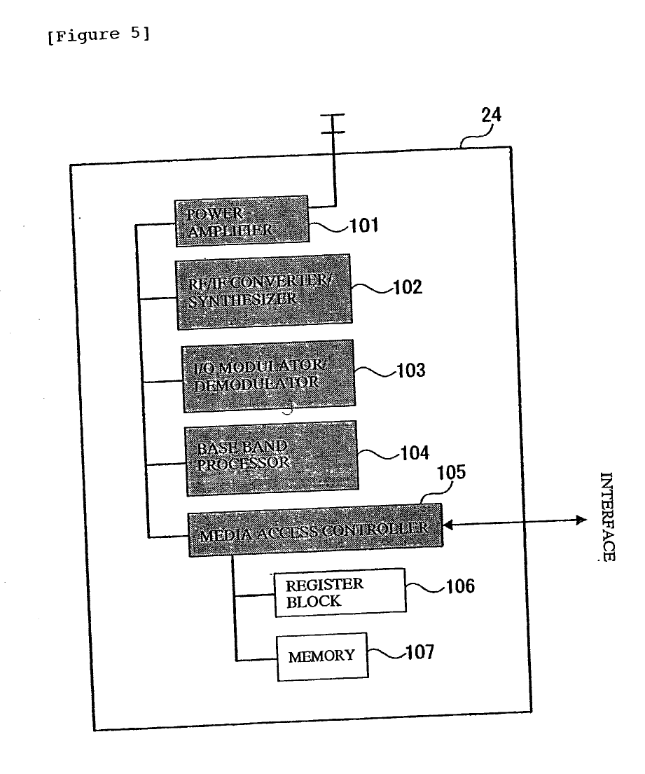

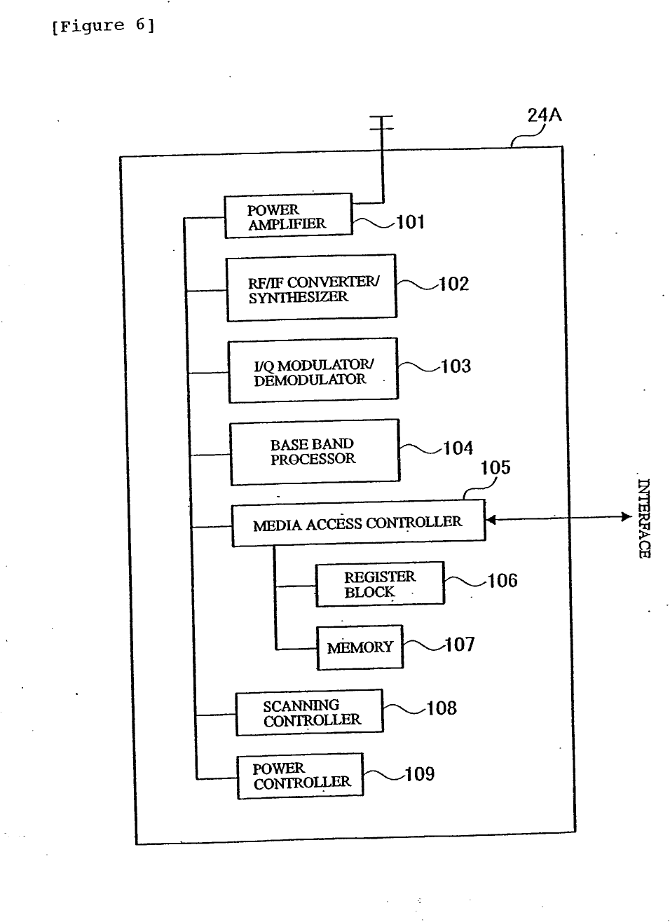

In this case, the deep sleep mode is set as a sleep mode as the operation mode of the wireless LAN card 24 (step S217). FIG. 5 shows how the components of the wireless LAN card 24 are powered in the deep sleep mode. In FIG. 5, the (hatched) components other than the register block 106 and the memory 107 are not powered. This state may be the same as the power supply state in the so-called suspend and power save modes of the computer system 10.

Then, it is checked in the deep sleep mode whether or not any event occurs in the computer system 10 (step S219). The event mentioned here may be, for example, a data input via the keyboard, a pointer movement via the mouse, a data input or signal input to the computer system 10 via the I/O port 46 from external, a power supply change-over (from the main battery 52 to the AC power supply), opening the cover of the computer system 10. When an event occurrence is detected, the operation mode of the wireless LAN card 24 is returned to the normal mode, then the access point scanning in step S201 is performed. Because the scanning idle time T is set to t2 (comparatively long) in step S215, when an event occurs while the computer system 10 has not been used for a time, the computer system 10 might have moved or the radio signal condition might have changed, thereby data sending/receiving to/from the access point is enabled. Consequently, access point scanning is done whenever necessary in the normal mode. On the other hand, when no event occurs, control goes to the processing in the next step S211.

When an operation mode of the wireless LAN card 24 is set in step S209 or S210, or when it is determined in step S219 that no event has occurred, it is then determined whether or not the scanning idle time T has already expired (step S211). When the scanning idle time T has not expired yet, the system waits until the time T is reached. On the other hand, when it is determined that the scanning idle time T has already expired, the operation mode of the wireless LAN card 24 is returned to the normal mode, then the system returns to step S201 to begin access point scanning.

When the use of the wireless LAN is set for the computer system 10 in this embodiment as described above, access point scanning is controlled and the operation mode of the wireless LAN card 24 is controlled. Concretely, the scanning idle time T is set according to whether or not communication with the target access point is enabled and the operation mode of the wireless LAN card is controlled according to the type of the power supply, thereby suppressing the power consumption. As a result, while the power consumption in the normal mode is usually 700 milliwatts, the power consumption in the power save mode can be reduced to 200 milliwatts and the power consumption in the deep sleep mode can be reduced to 30 milliwatts. The power consumption in the computer system 10 can thus be reduced significantly in this embodiment.

As described above, when compared with any of the conventional computer systems in which scanning waves are generated frequently until the user disables the use of the wireless LAN card 24, the computer system 10 of the present invention can avoid wasteful power consumption. In addition, when the main battery 52 is used, the operation time of the computer system 10 can be more extended than any of the conventional computer systems provided with a wireless LAN card.

Usually, it is expected that the main battery 52 is used outdoors, for example, away from office/home and during moving. In this case, it is difficult to send/receive data via a wireless LAN and omission of access point scanning is expected in many cases. In this embodiment, when communication with an access point is disabled, the number of scanning times is reduced. Thus, output of wasteful radio waves can be avoided. Consequently, it is possible to suppress adverse influences by generation of unnecessary radio waves, for example, to suppress generation of jamming radio waves that cause radio wave disturbance to air-crafts, etc.

In the above embodiment, the configuration of the wireless LAN card 24 is not limited only to that shown in FIG. 2.

FIG. 6 shows a variation of the block diagram of the wireless LAN card (wireless communication module) 24 shown in FIG. 2. The wireless LAN card 24A shown in FIG. 6 is provided with the components of the wireless LAN card 24 shown in FIG. 2, as well as a scanning controller 108 that controls access point scanning and a power controller (operation mode controller) 109 that controls a power supply in the wireless LAN card 24A. In this case, the scanning controller 108 can set the scanning idle time T in steps S205 and S215 in FIG. 3 respectively. The power controller 109 can determine whether or not an AC power supply is used to power the computer system 10 according to the information received from the I/O bridge 21 to control the normal mode, power save mode, or deep sleep mode as an operation mode. In this case, the power controller 109 may receive a signal from outside of the wireless LAN card 24A, for example, from the embedded controller 41 to control the operation mode of the wireless LAN card 24A.

Furthermore, the I/O bridge 21 can set the scanning idle time T and controls the operation mode in the wireless LAN card 24A.

In the above embodiment, when it is detected, in step S203 in FIG. 3, that communication with a target access point is disabled, the scanning idle time T is set to t2. This t2 may be set longer each time it is set continuously. For example, t2 is set to one minute for the first scanning. And, when it is also detected in step S203 that communication with the target access point is disabled, t2 is set to two minutes for the next scanning. It is also possible not to set t2 specially as the scanning idle time T and instead set the deep sleep mode until an event occurs.

Furthermore, in the above embodiment, the computer system 10 may also be provided with a device that notifies the user that any of the normal mode, the power save mode, and the deep sleep mode is set as the operation mode of the wireless LAN card 24. For example, an icon may be displayed at an end of the screen to notify the user that no radio wave is output.

Furthermore, in the above embodiment, when it is detected in step S203 in FIG. 3 that communication with a target access point is disabled, the power save mode can be set instead of the deep sleep mode. When it is determined in step S207 that the AC power supply is not used to power the computer system 10, the scanning idle time T can be set to t2.

The present invention also makes it possible to adjust which component is to be powered as needed in each operation mode (normal mode, power save mode, deep sleep mode, etc.).

Furthermore, the program as described in the above embodiment may be provided as a recording medium or program sending device as described below.

More specifically, the recording medium may be any of CD-ROMs, DVDs, memories, hard disks, etc. that can record the program so as to be read by computers.

The program sending unit may be any of those provided with such a recording unit as a CD-ROM, DVD, memory, hard disk, or the like used to record the above program; and a sending unit that sends the program to a device that reads the program from the recording device and executes the program via a connector or such a network as the Internet, LAN, or the like. Such the program sending unit will be suitable for installing a program used to execute the processings as described above.

While a wireless LAN module employed for a wireless LAN is used as a wireless communication module in the above embodiment, the wireless communication module of the present invention is not limited only to that; any module will do if it can change over communication among a plurality of access points.

While a lap-top PC is used as a computer in the above embodiment, the computer of the present invention is not limited only to that; any computer will do if it can send/receive data via a wireless communication module. For example, it may be a portable terminal such as a PDA (Personal Digital Assistant), portable telephone, or the like.

Furthermore, it is to be understood that changes and variations may be made for the above embodiment without departing from the spirit or scope of the invention.

What is claimed is:

1. A computer configured to connect a wireless communication module, comprising:
a power supply detection unit that detects whether or not an AC power supply is used to power said computer; and
an operation mode controller that controls an operation mode in said wireless communication module according to the decision of said power supply detection unit,
wherein, said computer is able to send/receive data to/from an access point.

2. The computer according to claim 1,
wherein said operation mode controller sets a first mode as said operation mode when said power supply detection unit detects that an AC power supply is used and sets a second mode as said operation mode when said power supply detection unit detects that said AC power supply is not used.

3. The computer according to claim 2,
wherein said first mode is a normal mode and said second mode is a power save mode.

4. The computer according to claim 1,
wherein said computer further includes:
a scanning controller that controls access point scanning; and
a detection unit that detects whether or not communication with an access point is enabled; and
said scanning controller, when said detection unit detects that said communication is disabled, sets an idle time until the next access point scanning begins, longer than when said detection unit detects that said communication is enabled.

5. The computer according to claim 4,
wherein said operation mode controller, when said detection unit detects that said communication is disabled, sets a third mode as said operation mode.

6. The computer according to claim 5,
wherein said scanning controller, when said third mode is set, makes said access point scanning upon an event occurrence.

7. The computer according to claim 6,
wherein said third mode is a sleep mode.

8. A computer provided with a wireless communication module, including:
a scanning controller that controls access point scanning; and
a detection unit that detects whether or not communication with an access point is enabled; and
said scanning controller, when said detection unit detects that communication with said access point is disabled, sets an idle time until the next access point scanning begins, longer than when said detection unit detects that said communication with said access point is enabled.

9. The computer according to claim 8,
wherein said computer further includes a detector that detects an event occurrence; and
said scanning controller, when said detection unit detects that said communication is disabled, stops access point scanning until said detector detects an event occurrence.

10. A wireless communication module that sends/receives data to/from an access point, comprising:
a scanning unit that scans an access point;
a detection unit that detects whether or not communication with said access point is enabled according to a result of scanning; and
an operation mode controller that controls an operation mode that selects a unit to be supplied with a power in said wireless communication module according to the decision of said detection unit.

11. The wireless communication module according to claim 10,
wherein said operation mode controller controls said operation mode according to a power supply type.

12. The wireless communication module according to claim 11,
wherein said operation mode controller sets a first mode as said operation mode when an AC power supply is used and sets a second mode when said AC power supply is not used.

13. The wireless communication module according to claim 10,
wherein said module further includes a setting device that, when said detection unit detects that communication with said access point is disabled in an initial scanning,
sets an idle time until the next scanning begins, longer than when said detection device detects that communication with said access point is enabled.

14. A wireless communication module connected to a computer and used to enable said computer to connect another device for wireless communication, comprising:
a first mode operation unit that operates said wireless communication module in a first mode when an AC power supply is used to power said computer; and
a second mode operation unit that operates said wireless communication module in a second mode when said AC power supply is not used to power said computer.

15 The wireless communication module according to claim 14,
wherein said module further includes:
a scanning unit that scans said access point; and
a third mode operation unit that operates said wireless communication module in a third mode when communication with said access point is disabled.

16. The wireless communication module according to claim 15,
wherein said scanning unit, when communication with said access point is enabled, stops the next scanning until an event occurs.

17. A method for controlling a wireless communication module that sends/receives data to/from an external network, comprising:
a step of scanning an access point;
a step of detecting whether or not communication with said access point is enabled; and
a step of setting t1 as an idle time until the next scanning begins when communication with said access point is enabled and sets t2 as an idle time until the next scanning begins when communication with said access point is disabled; and
said t1 and said t2 satisfy the condition of t1<t2.

18. The method according to claim 17,
wherein said method further includes:
a step of detecting whether or not an AC power supply is used to power said computer; and
a step of setting a first mode as said operation mode of said wireless communication module when an AC power supply is used to power said computer and sets a second mode as said operation mode when said AC power supply is not used to power said computer.

19. The method according to claim 17,
wherein said method further includes a step of setting a third mode as said operation mode of said wireless communication module when communication with said access point is disabled.

20. A program that enables a computer to execute:
a function for setting a first mode as an operation mode of a wireless communication module when an AC power supply is used to power said computer; and
a function for setting a second mode as said operation mode of said wireless communication module when said AC power supply is not used to power said computer.

21. The program according to claim 20;
wherein said program further enables said computer to execute:
a function for scanning an access point of a wireless communication radio wave; and
a function for setting an idle time until the next scanning begins according to the connection state of said access point after scanning said access point.

22. The program according to claim 21,
wherein said program further enables said computer to execute a function for setting said idle time longer than when said connection state of said access point disables sending/receiving of data when said connection state of said access point enables sending/receiving of data.

23. A recording medium that records a program to be executed by a computer so as to be read by said computer,
wherein said program enables said computer to execute:
a function for detecting whether or not an AC power supply is used to power said computer; and
a function for setting a first mode as an operation mode of a wireless communication module when said AC power supply is used
to power said computer and sets a second mode as said operation mode of said wireless communication module when said AC power supply is not used to power said computer.

24. The recording medium according to claim 23,
wherein said program further enables said computer to execute a function for setting an idle time until the next access point scanning begins, longer than when said state of connection to said access point disables sending/receiving of data when said state of connection to said access point enables sending/receiving of data.
